(19) United States
(12) Patent Application Publication
(10) Pub. No.: US 2014/0151579 A1
(43) Pub. Date: Jun. 5, 2014

(54) LIGHT REFLECTING DEVICE AND RELATED LIGHT CURING DEVICE

(71) Applicant: HON HAI PRECISION INDUSTRY CO., LTD., New Taipei (TW)

(72) Inventor: Li-Ying WANG HE, New Taipei (TW)

(73) Assignee: HON HAI PRECISION INDUSTRY CO., LTD., New Taipei (TW)

(21) Appl. No.: 13/873,153

(22) Filed: Apr. 29, 2013

(30) Foreign Application Priority Data
Dec. 4, 2012 (TW) 101145550

(51) Int. Cl. F21V 7/04

(52) U.S. Cl. CPC F21V 7/04
USPC 250/504 R; 362/346

(57) ABSTRACT

A light reflecting device comprises: two juxtaposed elongate sidewalls having inwardly curved inner surfaces facing each other; two opposite side panels, the sidewalls interposed and connected between the side panels, the side panel has flat inner surfaces facing each other and being perpendicular to a lengthwise direction of the sidewalls; and an elongate bottom wall interconnected between the sidewalls and the side panels, the bottom wall has an elongated outwardly curved inner surface interconnected between the inwardly curved inner surfaces.

### BACKGROUND

1. Technical Field

The present disclosure relates to a light reflecting device and a light curing device.

2. Description of Related Art

Many ultraviolet light curing devices include a light reflecting device and an ultraviolet lamp mounted in the light reflecting device. However, uniformity of the light emitted from the curing devices is unsatisfactory.

Therefore, it is desired to provide a light reflecting device and a light curing device which can overcome the above mentioned problem.

### BRIEF DESCRIPTION OF THE DRAWINGS

FIG. 1 is a schematic view of a light reflecting device according to a first embodiment.

FIG. 2 is a cross sectional view taking along line II-II of the light reflecting device of FIG. 1.

FIG. 3 is a schematic, isometric view of a light curing device according to a second embodiment.

FIG. 4 is an optical effect diagram of the light curing device of FIG. 3.

### DETAILED DESCRIPTION

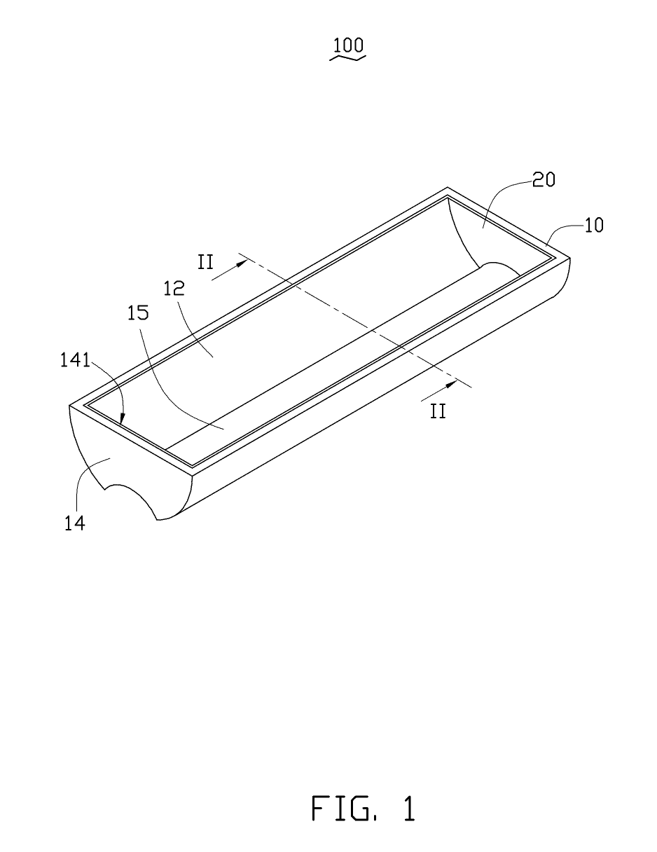

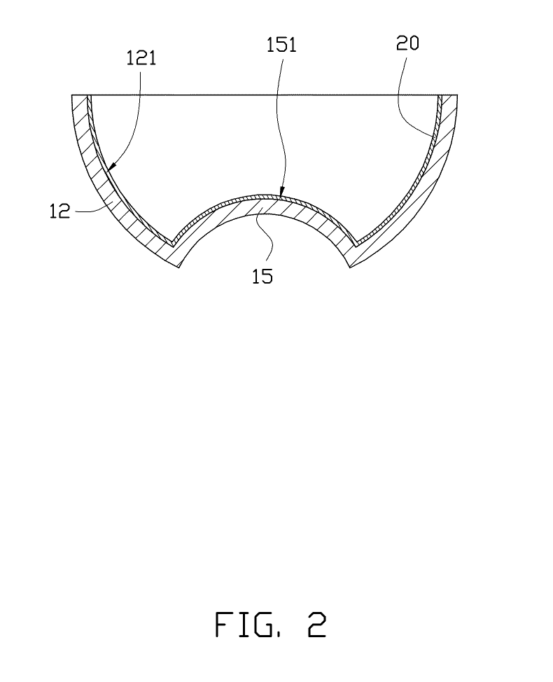

FIGS. 1 and 2 show a light reflecting device 100 according to a first embodiment. The light reflecting device 100 includes a groove-shaped cover 10 and a reflective layer 20 formed on the groove-shaped cover 10.

The cover 10 includes two juxtaposed elongate sidewalls 12; two opposite side panels 14 and an elongate bottom wall 15. The sidewalls 12 have inwardly curved inner surfaces 121 facing each other. The sidewalls 12 are interposed and connected between the side panels 14. The side panels 14 have flat inner surfaces 141 facing each other and are perpendicular to a lengthwise direction of the sidewalls 12. The elongate bottom wall 15 is interconnected between the sidewalls 12 and the side panels 14, and the bottom wall 15 has an outwardly curved inner surface 151 interconnected between the inwardly curved inner surfaces 121. A radius of an arc defined by each inwardly curved inner surface 121 is greater than a radius of an arc defined by the outwardly curved inner surface 151. In this embodiment, the arc defined by each inwardly curved inner surface 121 coincides with an arc of a circle; and the arc defined by the outwardly curved inner surface 151 coincides with an arc of another circle.

The reflective layer 20 is a metallic layer for increasing light reflectivity. Material of the layer 20 is selected from the group consisting of gold, silver, copper, aluminum and any combination thereof. The reflective layer 20 is formed on the inwardly curved inner surfaces 121, the flat inner surfaces 141, and the outwardly curved inner surface 151. In other embodiments, the groove-shaped cover 10 is made of metal, and the reflective layer 20 may be omitted.

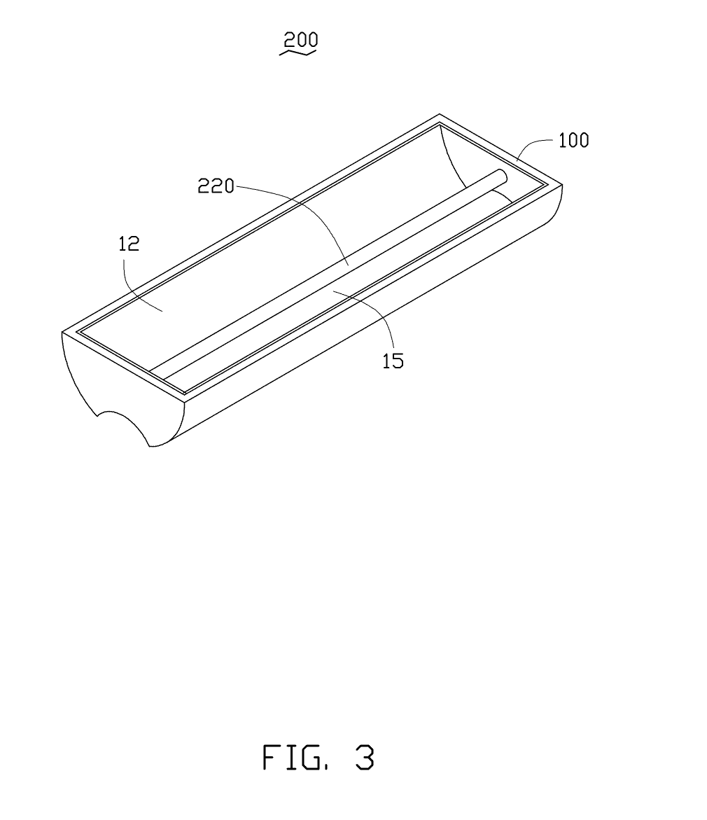

FIG. 3 shows a light curing device 200 according to a second embodiment. The light curing device 200 includes the light reflecting device 100 and an ultraviolet light bulb 220 received in the light reflecting device 100 mounted on the bottom wall 15.

In the embodiment, the ultraviolet light bulb 220 is oriented directly over the elongate bottom wall 15. A distance between the ultraviolet light bulb 220 and the outwardly curved inner surface 151 is less than or equal to about 5 mm, to achieve a good optical effect.

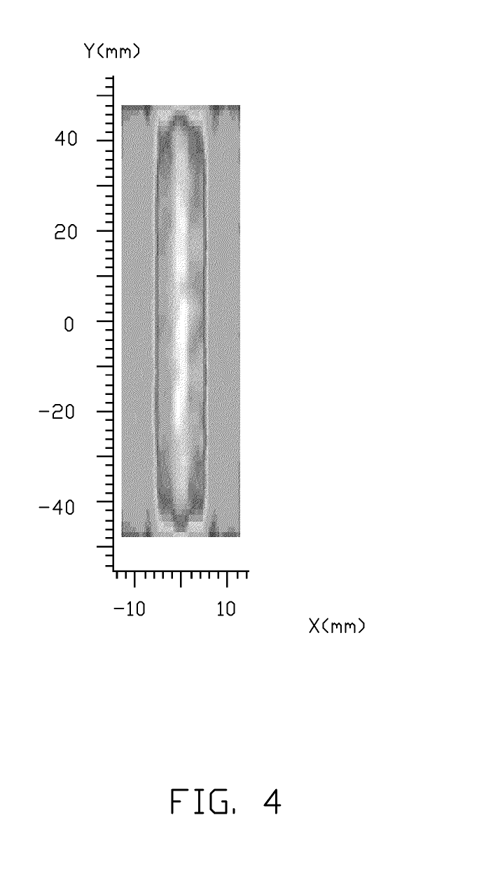

When employing the light curing device 200, the light curing device 200 is aimed at an object to be cured, light emitted from the ultraviolet light bulb 220 is uniformly reflected by the light reflecting device 100 onto the object. As shown in FIG. 4, the light emitted from the light curing device 200 is evenly dispersed. Uniformity of the light emitted from the light curing device 220 is satisfactory. Therefore, the object can be cured uniformly and the curing quality is improved.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A light reflecting device comprising:
two juxtaposed elongate sidewalls having inwardly curved inner surfaces facing each other;
two opposite side panels; the sidewalls interposed and connected between the side panels, the side panels having flat inner surfaces facing each other and being perpendicular to a lengthwise direction of the sidewalls; and
an elongate bottom wall interconnected between the sidewalls and the side panels, the bottom wall having an elongated outwardly curved inner surface interconnected between the inwardly curved inner surfaces.

2. The light reflecting device of claim 1, wherein a radius of an arc defined by each inwardly curved inner surface is greater than a radius of an arc defined by the outwardly curved inner surface.

3. The light reflecting device of claim 1, further comprising a reflecting layer formed on the outwardly curved inner surface, the flat inner surfaces and the inwardly curved inner surfaces.

4. The light reflecting device of claim 1, wherein the reflecting layer is made of metal.

5. The light reflecting device of claim 1, wherein the metal is selected from the group consisting of gold, silver, copper, aluminum and any combination thereof.

6. A light curing device, comprising:
a light reflecting device comprising:
two juxtaposed elongate sidewalls having inwardly curved inner surfaces facing each other;
two opposite side panels; the sidewalls interposed and connected between the side panels, the side panel having flat inner surfaces facing each other and being perpendicular to a lengthwise direction of the sidewalls; and
an elongate bottom wall interconnected between the sidewalls and the side panels, the bottom wall having an elongated outwardly curved inner surface interconnected between the inwardly curved inner surfaces; and
an ultraviolet light bulb received in the light reflecting device and mounted on the bottom wall.

7. The light curing device of claim 6, wherein a distance between the ultraviolet light bulb and the outwardly curved inner surface is less than about 5 mm.

8. The light curing device of claim 6, wherein a distance between the ultraviolet light bulb and the outwardly curved inner surface is equal to about 5 mm.

9. The light curing device claim 6, wherein a radius of an arc defined by each inwardly curved inner surface is greater than a radius of an arc defined by the outwardly curved inner surface.

10. The light curing device of claim 6, wherein the light reflecting device further comprising a reflecting layer formed on the outwardly curved inner surface, the flat inner surfaces and the inwardly curved inner surfaces.

11. The light curing device of claim 6, wherein the reflecting layer is made of metal.

12. The light curing device of claim 6, wherein the metal is selected from the group consisting of gold, silver, copper, aluminum and any combination thereof.
